(19) United States
(12) Patent Application Publication
(10) Pub. No.: US 2004/0235382 A1
(43) Pub. Date: Nov. 25, 2004

(54) Mat for the computer input device known as a mouse

(75) Inventors: Robert Groten, Sundhoffen (FR); Georges Riboulet, Colmar (FR); Ulrich Jahn, Labaroche (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/849,406

(22) Filed: May 19, 2004

(30) Foreign Application Priority Data
May 23, 2003 (DE) DE 103 23 790.9

(51) Int. Cl. B32B 9/00; D04H 3/00; B32B 5/24; B32B 33/00; D04B 21/14

(52) U.S. Cl. 442/199; 442/221; 442/308; 442/315; 442/370; 442/340; 442/361; 442/408; 442/347

(57) ABSTRACT

A mat for the computer input device known as a mouse (mouse pad) has at least one woven or knit layer or one layer of non-woven fabric made of bi-component or multi-component fibers or filaments split to form microfibers or microfilaments. The splitting is performed by high-pressure fluid jet treatment of the surface.

This claims the benefit of German Patent Application No. 103 23 790.9, filed May 23, 2003 and hereby incorporated by reference herein.

### BACKGROUND

The present invention pertains to a mat for the computer input device known as a mouse (mouse pad).

A mat, in particular a tracking ball mat, is known from the German Patent Document No. DE 297 22 764 U1, this pad being part of a printable sheet in an inkjet printer and provided with a non-slip coating on the underside. In this case, the base has a cellulose non-woven fabric prepared with latex or acrylic resin and the printing ink is fixed by being briefly heated. In addition, non-woven fabrics are known from Japanese Patent Document No. JP 09 241 959 that consist of very fine fibers and that are impregnated with a resin. The ends of the fibers at the surface exhibit a hammerhead shape. Such a mouse pad may exhibit good dust absorption capabilities. Japanese Patent Document No. JP 10 312 240 describes a mouse pad having a surface made of woven textiles with a fiber fineness of 0.05 to 1 denier and a back made of elastic non-woven fabric consisting of fibers having a diameter of 0.1 to 20 μm, a density of 0.1 to 0.4 g/cm² and a thickness of 0.1 to 0.5 mm. Such a mouse pad ensures good operation of the computer mouse and makes it easy to remove dirt.

In many mouse pads, impurities, in particular due to sweat and oil produced by the skin of the hand, become firmly attached to the mat or inside the mouse. This results in very high wear and tear on the mouse pad with regard to the printed pattern or a large maintenance expenditure for the computer mouse.

### BRIEF SUMMARY OF THE INVENTION

An object of the invention is to specify a mat for the computer input device known as a mouse, this mat reducing the disadvantages stated above.

The present invention provides a mat (mouse pad) comprising at least one woven or knit layer or one layer of non-woven fabric made of bi-component or multi-component fibers or filaments split to form microfibers or microfilaments. The mat of the present invention absorbs sweat and skin oils well and provides a good grip for the mouse tracking ball.

Advantageously, the titer of the microfibers or microfilaments may range from 0.05 to 0.5 dtex.

A mat having a foam layer on its underside is particularly preferred. Such a mouse pad exhibits pleasing operation and non-slip characteristics.

Advantageously, the top of a mouse pad according to the invention is imprinted. Unexpectedly, imprinting using a commercially available inkjet printer on the material obtained by using water jet compacting and splitting is adequately colorfast, even without additional impregnation with a resin, if the mouse pad is subsequently fixed onto the foam layer with the help of a hot-melt adhesive through ironing.

Advantageously, the microfiber or microfilament area material may be provided with a foam layer on the underside. Preferably, the foam layer is attached using a hot-melt adhesive. The top of the split material is imprinted before being bonded to the foam layer. Preferably, the imprinting is performed on the surface compacted by the high-pressure fluid jet treatment.

The method of the present invention makes use of a woven or knit layer or a non-woven fabric layer made of bi-component or multi-component fibers or filaments split to form microfibers or microfilaments by high-power fluid jet treatment of the surface. This process is also known as spinlacing or hydrolacing.

The high-power fluid jet treatment of the surface may be performed at least once on a side at pressures of 50 to 500 bar.

The imprinting may be performed on the opposite side of the last passage of the surface compacted via the high-pressure fluid jet treatment. The imprinting may be performed using offset or transfer printing, binder printing, rotogravure or inkjet printing. The imprinting may also be performed using industrial or home-use inkjet printers.

### BRIEF DESCRIPTION OF THE DRAWING

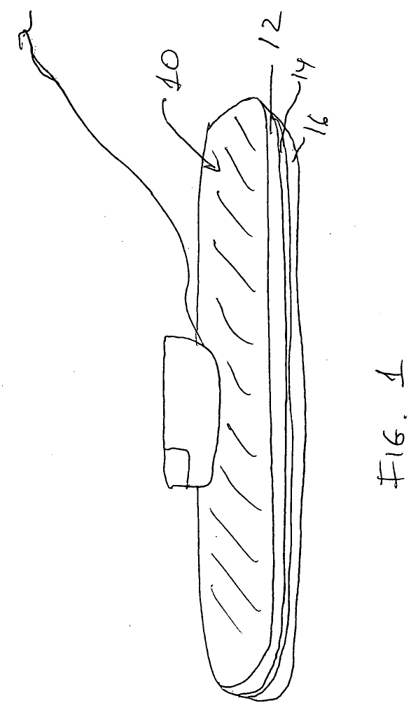

The present invention will be described in more detail with respect to FIG. 1, in which a mouse pad according to the present invention is shown.

### DETAILED DESCRIPTION

The present invention is explained in more detail below using two examples, with the first example being described with respect to the mouse pad 10 shown in FIG. 1.

### EXAMPLE 1

A web having an area weight of 170 g/m² is laid using splittable bi-component staple fibers and the bi-component fibers are split and compacted at the same time into microfibers having a titer of <0.2 dtex using a water jet treatment at pressures of <350 bar. The compacted microfiber textile 12 is printed in a conventional inkjet printer, provided on its back with a hot-melt adhesive 14, and ironed onto a foam layer 16 to form mouse pad 10. The printing remains in good condition for about one year without cleaning.

### EXAMPLE 2

A splittable bi-component filament is initially compacted using an embroidering loom after being drawn and laid down on a porous ribbon, and then split and compacted into a microfilament textile having a stiffness similar to that of paper using a two-sided water jet treatment at pressures of <220 bar. This material can be directly imprinted by a conventional inkjet printer and fastened onto a foam base by ironing using a hot-melt adhesive. The mouse pad of the present invention does not reveal moisture due to sweat on the surface and is therefore very comfortable for the hand of the user. The mouse pad of the present invention provides a good grip and therefore provides good motion tracking of the control ball. Single-colored surfaces show little soiling within two years and make cleaning of the mouse pad and of the computer mouse unnecessary for this time.

What is claimed is:

1. A mat for a computer mouse comprising:
a first layer having a surface, the first layer being at least one woven or knit layer or a layer of non-woven fabric made of bi-component or multi-component fibers or filaments split to form microfibers or microfilaments by high-pressure fluid jet treatment of the surface.

2. The mat as recited in claim 1 wherein the titer of the microfibers or microfilaments ranges from 0.05 to 0.5 dtex.

3. The mat as recited in claim 1 further comprising a foam layer on an underside of the first layer.

4. The mat as recited in claim 1 wherein a top of the first layer is imprinted.

5. A method for producing a computer mouse mat comprising:
using a high pressure fluid jet to treat a surface of a woven or knit layer or a layer of non-woven fabric made of bi-component or multi-component fibers or filaments, the high pressure fluid jet causing splitting to form microfibers or microfilaments.

6. The method as recited in claim 5 wherein the high-power fluid jet treatment of the surface is performed at least once on a side at pressures of 50 to 500 bar.

7. The method as recited in claim 5 further comprising attaching a foam layer to an underside of the woven or knit or non-woven fabric layer.

8. The method as recited in claim 7 wherein the foam layer is attached using a hot-melt adhesive.

9. The method as recited in claim 7 further comprising imprinting a top of the woven or knit or non-woven fabric layer before attaching the foam layer.

10. The method as recited in claim 9 wherein the top is opposite the surface last compacted via the high-pressure fluid jet treatment.

11. The method as recited in claim 10 wherein the imprinting is performed using offset or transfer printing, binder printing, rotogravure or inkjet printing.

12. The method as recited in claim 10 wherein imprinting is performed using industrial or home-use inkjet printers.
